(19) United States
(12) Patent Application Publication
(10) Pub. No.: US 2024/0282492 A1
(43) Pub. Date: Aug. 22, 2024

(54) DUST CORE, INDUCTOR, AND ELECTRONIC/ELECTRIC DEVICE

(71) Applicant: Alps Alpine Co., Ltd., Tokyo (JP)

(72) Inventors: Akinori KOJIMA, Niigata-ken (JP); Hiroya SAWAIRI, Niigata-ken (JP)

(21) Appl. No.: 18/399,214

(22) Filed: Dec. 28, 2023

(30) Foreign Application Priority Data
Feb. 20, 2023 (JP) 2023-024569

(51) Int. Cl. H01F 1/153; H01F 1/147; H01F 3/08; H01F 27/255; H01F 41/02

(52) U.S. Cl. CPC H01F 1/15308; H01F 1/14733; H01F 1/14766; H01F 1/15333; H01F 3/08; H01F 27/255; H01F 41/0246

(57) ABSTRACT

A dust core includes a soft magnetic metal powder containing a plurality of crystalline particles and a plurality of amorphous particles. The median diameter D50c of the plurality of crystalline particles is 1.3 μm or less, and the median diameter D50a the plurality of amorphous particles is 2.0 μm or more and 12.0 μm or less. The median diameter D50 of the soft magnetic metal powder is calculated by a formula: D50=(Rc×D50c+Ra×D50a)/100, which is equal to or greater than 1.8 μm and equal to or smaller than 7.0 μm. In the formula, Rc is the mass ratio (unit: % by mass) of the plurality of crystalline particles relative to the soft magnetic metal powder, and Ra is the mass ratio (unit: % by mass) of the plurality of amorphous particles relative to the soft magnetic metal powder.

### CLAIM OF PRIORITY

This application claims benefit of Japanese Patent Application No. 2023-024569 filed on Feb. 20, 2023, which is hereby incorporated by reference.

### BACKGROUND OF THE INVENTION

### 1. Field of the Invention

The present invention relates to a dust core, an inductor including the dust core, and an electronic/electric device implemented with the inductor. In the present specification, the “inductor” represents a passive component including a core material, containing a dust core, and a coil.

### 2. Description of the Related Art

There are increasing requirements for smaller sizes, lighter weights, and higher performance of electronic devices. In order to comply with the requirements, a switching power source circuit in an electronic device is required to be capable of corresponding to a high frequency. Therefore, the inductor incorporated into the switching power source circuit is also required to be capable of being stably driven at a high frequency.

In recent year, there have been increasing requirements for miniaturization of a switching power source circuit, particularly a DC-DC converter, incorporated into an electronic device, such as a smartphone, tablet terminal, a note personal computer, or the like. As a result of complying with the requirements, the inductor incorporated inside becomes small in size, but a large direct current is made to flow therethrough. Therefore, the magnetic environment in which a magnetic material constituting the inductor is placed becomes an environment in which a variable magnetic field caused by current fluctuation (ripple current) based on switching at a high frequency is further applied in a state where an induction magnetic field caused by a direct current is applied as bias. Therefore, the magnetic member constituting the inductor becomes required to have proper magnetic characteristics (for example, high relative permeability, a high DC superimposition rated current, and a low iron loss) in such a sever magnetic environment. The high relative permeability represents that inductance is easily increased, the high DC superimposition rated current represents that the size is easily made small, and the small iron loss represents that the power efficiency is easily increased.

In order to comply with these requirements, a dust core formed by mixing a plurality of magnetic powders is proposed as a dust core which is one of the magnetic members constituting the inductor (For example, Japanese Unexamined Patent Application Publication No. 2010-118486, International Publication No. 2020/090405, Japanese Unexamined Patent Application Publication No. 2020-72182, and Japanese Unexamined Patent Application Publication No. 2022-37533).

### SUMMARY OF THE INVENTION

In consideration of the present situation, the present invention provides a dust core suitable as a constituent member of an inductor which has good magnetic characteristics even in a severe magnetic environment and which can comply with miniaturization, an inductor including the dust core, and an electronic/electric device implemented with the inductor.

According to an aspect of the present invention, a dust core contains a soft magnetic metal powder, the soft magnetic metal powder containing a plurality of crystalline particles and a plurality of amorphous particles. The median diameter D50c of the plurality of crystalline particles is 1.3 μm or less, and the median diameter D50a the plurality of amorphous particles is 2.0 μm or more and 12.0 μm or less. The crystalline particles have a composition containing Fe and Ni, and the median diameter D50 of the soft magnetic metal powder is calculated by formula (1) below and is 1.8 μm or more and 7.0 μm or less.

$$D 50 = ( R c \times D 50 c + R a \times D 50 a ) / 100 \qquad ( 1 )$$

In the formula, Rc is the mass ratio (unit: % by mass) of the plurality of crystalline particles relative to the soft magnetic metal powder, and Ra is the mass ratio (unit: % by mass) of the plurality of amorphous particles relative to the soft magnetic metal powder.

The dust core having the configuration described above can increase the overall characteristic (μ²×Isat/Pcv) of an inductor. With respect to the overall characteristic, u is relative initial permeability at 1 MHz, Pcv is iron loss at 1 MHz, and Isat is DC superimposition rated current (a current value at which self-inductance Lis decreased by 30% due to DC superimposition).

In the dust core, the metallic portion of the amorphous particles may be composed of an amorphous phase.

In the dust core, the median diameter D50a of the plurality of amorphous particles may be 3.5 μm or more and 9.0 μm or less. The median diameter D50c the plurality of crystalline particles may be 0.50 μm or more and 1.3 μm or less.

In the dust core, the mass ratio Ra of the plurality of amorphous particles relative to the soft magnetic metal powder may be 10% by mass or more and 90% by mass or less. The mass ratio Ra of the plurality of amorphous particles relative to the soft magnetic metal powder may be 35% by mass or more and 85% by mass or less.

In the dust core, the plurality of crystalline particles may have a composition containing 10% by mass or more and 90% by mass or less of Ni, and the balance composed of Fe and impurities.

In the dust core, the plurality of amorphous particles may have a metallic portion having a composition containing 5.0 to 13.0 atomic % of P, 2.2 to 13.0 atomic % of C, 0 to 10.0 atomic % of Ni, 0 to 9.0 atomic % of B, 0 to 7.0 atomic % of Si, 0 to 6.0 atomic % of Cr, 0 to 3.0 atomic % of Sn, and the balance composed of Fe and impurities. In the composition, Ni, B, Si, Cr, and Sn are arbitrarily added elements.

In the dust core, the plurality of amorphous particles may include first particles having a metallic portion composed of an amorphous phase, and second particles having a metallic portion composed of a crystal phase, having a Scherrer diameter of 50 nm or less, and an amorphous phase.

In the dust core including the first particles and the second particles, the mass ratio Ra2 of the second particles relative to the plurality of amorphous particles may be 80% by mass or less or may be 1% by mass or more and 60% by mass or less.

In the dust core including the first particles and the second particles, the median diameter D50a1 of the first particles may be 3.5 μm or more and 9.0 μm or less. The median diameter D50a2 the second particles may be 2.0 μm or more and 15 μm or less.

In the dust core including the first particles and the second particles, the median diameter D50a of the plurality of amorphous particles is calculated by formula (2) below and may be 3.0 μm or more and 8.0 μm or less.

$$D 50 a = ( Ra 1 \times D 50 a 1 + Ra 2 \times D 50 a 2 ) / 100 \qquad ( 2 )$$

In the formula, as described above, Ra1 is the mass ratio (unit: % by mass) of the first particles relative to the plurality of amorphous particles, and Ra2 is the mass ratio (unit: % by mass) of the second particles relative to the plurality of amorphous particles.

In the dust core including the first particles and the second particles, the median diameter D50c of the plurality of crystalline particles may be 0.5 μm or more and 1.3 μm or less. The mass ratio Ra of the plurality of amorphous particles relative to the soft magnetic metal powder may be 10% by mass or more and 90% by mass less or may be 35% by mass or more and 60% by mass or less.

In the dust core including the first particles and the second particles, the plurality of crystalline particles may have a metallic portion having a composition containing 10% by mass or more and 90% by mass or less of Ni and the balance composed of Fe and impurities.

In the dust core including the first particles and the second particles, the plurality of amorphous particles may have a metallic portion having a composition containing 5.0 to 13.0 atomic % of P, 2.2 to 13.0 atomic % of C, 0 to 10.0 atomic % of Ni, 0 to 9.0 atomic % of B, 0 to 7.0 atomic % of Si, 0 to 6.0 atomic % of Cr, 0 to 3.0 atomic % of Sn, and the balance composed of Fe and impurities. In the composition, Ni, B, Si, Cr, and Sn are arbitrarily added elements.

In the dust core including the first particles and the second particles, the second particles may have a composition containing 5 atomic % or more and 20 atomic % or less of one or more elements X selected from the group consisting of C, B, P, and Si, 1 atomic % or more and 10 atomic % or less of one or more elements M selected from the group consisting of Mo, Nb, Cu, Zr, Al, and V, and the balance composed of Fe and impurities.

In the dust core, D50a of the plurality of amorphous particles may be 3.5 μm or more and 9.0 μm or less, D50c of the plurality of crystalline particles may be 0.50 μm or more and 1.3 μm or less, and the mass ratio Ra of the plurality of amorphous particles relative to the soft magnetic metal powder may be 35% by mass or more and 60% by mass less. The plurality of amorphous particles may have a composition containing 5.0 to 13.0 atomic % of P, 2.2 to 13.0 atomic % of C, 0 to 10.0 atomic % of Ni, 0 to 9.0 atomic % of B, 0 to 7.0 atomic % of Si, 0 to 6.0 atomic % of Cr, 0 to 3.0 atomic % of Sn, and the balance composed of Fe and impurities, and have a metallic portion composed of an amorphous phase. In the composition, Ni, B, Si, Cr, and Sn are arbitrarily added elements.

When the dust core is measured under the conditions including a frequency of 1 MHz and an effective maximum magnetic flux density Bm of 15 mT, the iron loss Pcv may be 70 KW⁻¹ m³ or less. A dust core according to another aspect of the present invention contains a soft magnetic metal powder, the soft magnetic metal powder containing a plurality of crystalline particles and a plurality of amorphous particles. When a section of the dust core is observed, the dust core has the following characteristics.

The average equivalent circular diameter of the plurality of crystalline particles is 1.0 μm or less.

The average equivalent circular diameter of the plurality of amorphous particles is 1.0 μm or more and 8.0 μm or less.

The ratio of the occupied sectional area of the plurality of amorphous particles in an observation field to the occupied sectional area of the soft magnetic metal powder in the observation field is 30% or more 70% or less.

In another aspect, the present invention provides an inductor including a connection terminal, a conductor electrically connected to the connection terminal and capable of generating an induction magnetic field by electric conduction, and the dust core described above. In the inductor, the dust core is disposed at a position through which a line of magnetic force of the induction magnetic field from the conductor passes.

In a further aspect, the present invention provides an electronic/electric device implemented with the inductor according to an aspect of the present invention. In the electronic/electric device, the inductor is connected to a substrate through the connection terminal. In the electronic/electric device, a circuit with the inductor incorporated thereinto is not particularly limited, but when used in a switching power source circuit such as a DC-DC converter, it is easy to take advantage of the inductor that the DC superimposition characteristic is excellent. Also, when the electronic/electric device is a portable-type device such as a smartphone or the like, it is easy to take advantage of the inductor that it easily complies with small size and low height.

### BRIEF DESCRIPTION OF THE DRAWINGS

FIG. 1 is a perspective view schematically showing the shape of a dust core according to an embodiment of the present invention;

FIG. 2 is a drawing schematically showing a spray dryer device and the operation thereof used in an example of a method for producing a granulated powder;

FIG. 3 is a perspective view schematically showing the shape of a toroidal coil as a type of an inductor including a dust core according to an embodiment of the present invention;

FIG. 4 is a perspective view schematically showing the shape of a coil-embedded type inductor as a type of an inductor including a dust core according to an embodiment of the present invention;

FIG. 5 is a graph illustrating the characteristics of an inductor including a dust core according to an embodiment of the present invention;

FIG. 6 is a graph illustrating the relationship between the characteristics and median diameter D50 of an inductor including a dust core according to an embodiment of the present invention;

FIG. 7 is a graph showing the results shown in Example 26 to Example 29;

FIG. 8 is a graph showing the results shown in Example 30 to Example 33;

FIG. 9 is a diagram showing a secondary electron image of a section of a dust core according to Example 5-3; and

FIGS. 10A through 10E are Tables 1 through Table 5 summarizing calculated and/or measured data, manufacturing conditions, and resulting characteristics of a dust core in various examples.

### DESCRIPTION OF THE PREFERRED EMBODIMENTS

Embodiments of the present invention are described in detail below.

### 1. Dust Core

### (1) Summary

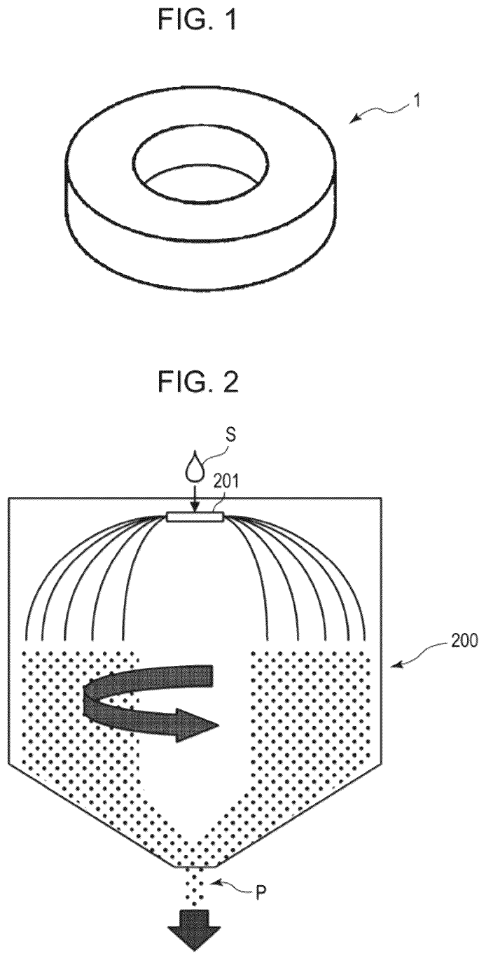

A dust core 1 according to an embodiment of the present invention shown in FIG. 1 is a toroidal core having a ring-shaped outside appearance and contains a soft magnetic metal powder. The soft magnetic metal powder contains a plurality of types, specifically, a plurality of crystalline particles and a plurality of amorphous particles. For each of the plurality of types of metal powders, the median diameter (unit; μm) is determined, which is the particle diameter at 50% of cumulative particle diameter distribution from the smaller particle diameter side in a volume-based particle size distribution measured by a laser diffraction/scattering method. As a result, the median diameter D50c of the plurality of crystalline particles is 1.3 μm or less, and the median diameter D50a the plurality of amorphous particles is 2.0 μm or more and 12.0 μm or less. The median diameter D50 of the soft magenta metal powder containing the plurality types of particles is approximately calculated by formula (1) below and is 1.8 μm or more and 7.0 μm or less.

D50=(Rc×D50c+Ra×D50a)/100 (1)

In the formula, Rc is the mass ratio (unit: % by mass) of the plurality of crystalline particles relative to the soft magnetic metal powder, and Ra is the mass ratio (unit: % by mass) of the plurality of amorphous particles relative to the soft magnetic metal powder.

The soft magnetic metal powder of the dust core 1 according to the embodiment satisfies conditions related to the particle diameters described above, and further the plurality of crystalline particles satisfies the condition (containing Fe and Ni) for the composition described below, thereby showing low initial permeability (relative initial permeability u), low iron loss Pcv, and excellent DC superimposition characteristic. In the specification, the DC superimposition characteristic is evaluated by DC superimposition rated current Isat (a current value at which the self-inductance L of an inductor is decreased by 30% due to DC superimposition). Specifically, the DC superimposition rated current Isat is a value measured by flowing current to an inductor formed by wining 34 turns of wire on a toroidal shaped core having an outer diameter of 20 mm, an inner diameter of 12.7 mm, and a height of 3.1 mm. The dust core 1 according to the embodiment and the inductor including it have the appropriate characteristics described above and thus have the excellent overall characteristic (μ²×Isat/Pcv). Therefore, the inductor including the dust core 1 according to the embodiment shows the excellent characteristics under the severe magnetic condition such as a large current or the like and can be miniaturized.

### (2) Crystalline Particles

The dust core 1 according to the embodiment contains a plurality of particles (crystalline particles) having soft magnetism and containing a crystal phase. In the specification, the term “crystalline” represents being capable of obtaining a diffraction spectrum having such a clear peak that the material type can be specified by general X-ray diffraction measurement.

As described above, the median diameter D50c of the plurality of crystalline particles is 1.3 μm or less, and with such a small median diameter D50c, a decrease in iron loss Pcv of the dust core 1 and improvement in DC superimposition characteristic of the inductor including the dust core 1 are realized. From the viewpoint of suitable handleability, suitable availability, and improvement in magnetic characteristics, the median diameter D50c of the plurality of crystalline particles may be preferably 0.50 μm or more and 1.0 μm or less.

The particle diameter of the plurality of crystalline particles can also be obtained by analyzing an image (secondary electron image) obtained by photographing a section of the dust core 1 using a scanning electron microscope. In this case, the average equivalent circular diameter of the plurality of crystalline particles in an observation field may be 1.0 μm or less, and is preferably 0.3 μm or more and 0.7 μm or less. As described in examples, the average equivalent circular diameter of particles determined from a secondary electron image is obtained as a value of about 60% to 70% (in examples, 63%) of the median diameter in the particle size distribution measured by a laser diffraction/scattering method.

The mass ratio Rc of the plurality of crystalline particles relative to the soft magnetic metal powder may be preferably 10% by mass or more and 90% by mass or less and may be more preferably 10% by mass or more and less than 50% by mass. The plurality of crystalline particles are softer than the plurality of amorphous particles and are deformed so as to fill between the plurality of amorphous particles in the dust core 1. Therefore, when the mass ratio Rc<the mass ratio Ra, the core density in the inductor including the dust core 1 can be increased, and thus the DC superimposition characteristic is hardly decreased.

The composition of the plurality of crystalline particles contains Fe and Ni and is preferably composed of Fe and Ni. The dust core 1 having the composition described above has low iron loss Pcv, and the DC superimposition characteristic of the inductor including the dust core 1 is easily improved, as compared with when the composition of the plurality of crystalline particles contains other elements, for example, Si and Cr, in place of Ni. In particular, when the composition of the plurality of crystalline particles is composed of Fe and Ni, the iron loss Pcv can be decreased by decreasing the annealing temperature in annealing treatment of the process for producing the dust core 1. When the composition is composed of Fe, Si, and Cr, the tendency described above is not observed, and rather the opposite tendency (the iron loss Pcv is increased with decreasing annealing temperature) is observed.

From the viewpoint of enhancing the magnetic characteristics of the plurality of crystalline particles, the composition of the plurality of crystalline particles more preferably contains 10% by mass or more and 90% by mass or less of Ni and the balance composed of Fe and impurities, and the composition particularly preferably contains 40% by mass or more and 60% by mass or less of Ni.

Also, the metallic portion of the plurality of crystalline particles preferably contains substantially no amorphous phase. In this case, the DSC curve obtained by differential thermal analysis does not contain a peak showing crystallization, that is, an exothermic peak associated with a phase change from an amorphous phase to a crystal phase. The structure of the plurality of crystalline particles may be composed of a crystal phase.

### (3) Amorphous Particles

The dust core 1 according to the embodiment contains a plurality of particles (amorphous particles) having soft magnetism and containing an amorphous phase. In the specification, the term “amorphous” represents satisfying at least one of: (A) a diffraction spectrum obtained by a general X-ray diffraction method contains a broad peak; and (B) a DSC curve obtained by differential thermal analysis contains a peak showing crystallization, that is, an exothermic peak associated with a phase change from an amorphous phase to a crystal phase. The metallic portion of the plurality of amorphous particles may be composed of only an amorphous phase or may contain an amorphous phase and a crystal phase.

As described above, the median diameter D50a of the plurality of amorphous particles is 2.0 μm or more and 12.0 μm or less. With the median diameter D50a within the range described above, a decrease in iron loss Pcv of the dust core 1 is realized. From the viewpoint of suitable handleability, suitable availability, and improvement in magnetic characteristics, the median diameter D50a may be preferably 3.5 μm or more and 9.0 μm or less.

The particle diameter of the plurality of amorphous particles can also be obtained by analyzing an image (secondary electron image) obtained by photographing a section of the dust core 1 using a scanning electron microscope. In this case, the average equivalent circular diameter of the plurality of amorphous particles in an observation field may be 1.0 μm or more and 8.5 μm less, and is preferably 2.0 μm or more and 6.5 μm or less.

From the viewpoint of more stably decreasing the iron loss Pcv and more stably enhancing the DC superimposition characteristic in the inductor including the dust core 1, the mass ratio Ra of the plurality of amorphous particles relative to the soft magnetic metal powder may be preferably 10% by mass or more and 90% by mass or less and more preferably 30% by mass or more and less than 85% by mass.

When the metallic portion of the amorphous particles is substantially composed of an amorphous phase (single-phase amorphous particles, first particles), for example, the metallic portion of the amorphous particles has a composition containing B and P.

For example, the metallic portion of the amorphous particles is composed of a Fe—P—C-based alloy. The composition of the Fe—P—C-based alloy may be composed of 1.0 to 13.0 atomic % of P, 1.0 to 13.0 atomic % of C, Fe, and impurities. The Fe—P—C-based alloy may contain, as arbitrary elements, one or more elements selected from the group consisting of Ni, Sn, Cr, B, and Si. In this case, for example, the amount of Ni may be 0 to 10.0 atomic %, the amount of Sn may be 0 to 3.0 atomic %, the amount of Cr may be 0 to 6.0 atomic %, the amount of B may be 0 to 9.0 atomic %, and the amount of Si may be 0 to 7.0 atomic %. The amount of Fe is preferably 65 atomic % or more.

A specific example of the Fe—P—C-based alloy is an alloy having the following composition containing:
P: 5.0 atomic % or more and 13.0 atomic % or less;
C: 2.2 atomic % or more 13.0 atomic % or less;
Ni: 10.0 atomic % or less;
B: 9.0 atomic % or less;
Si: 7.0 atomic % or less;
Cr: 6.0 atomic % or less; and
Sn: 3.0 atomic % or less,
where the balance contains Fe and impurities.

In the composition described above, Ni, B, Si, Cr, and Sn are arbitrary elements. Therefore, the lower limit of the amount of each of the arbitrary elements is 0 atom %.

Also, the metallic portion of the amorphous particles is composed of, for example, a Fe—B—C-based alloy. A specific example of the Fe—B—C-based alloy is an alloy having the following composition containing:
B: 5.0 atomic % or more and 16.0 atomic % or less;
C: 2.0 atomic % or more 10.0 atomic % or less;
Si: 12.0 atomic % or less;
Ni: 10.0 atomic % or less;
Cr: 6.0 atomic % or less; and
Sn: 3.0 atomic % or less,
   where the balance contains Fe and impurities.

In the composition described above, Ni, B, Si, Cr, and Sn are arbitrary elements. Therefore, the lower limit of the amount of each of the arbitrary elements is 0 atom %. In this case, the amount of C is preferably 5.0 atom % or more.

When the plurality of amorphous particles has an amorphous phase and a crystal phase, for example, the plurality of amorphous particles are nano-crystal particles (second particles) having a metallic portion containing a crystal phase having a Scherrer diameter of 50 nm or less. The metallic portion may be composed of a crystal phase having a Scherrer diameter of 50 nm or less and an amorphous phase surrounding the crystal phase.

As a non-limited example, the second particle may have a composition containing 5 atomic % or more and 20 atomic % or less of one or more elements X selected from the group consisting of C, B, P, and Si, 1 atomic % or more and 10 atomic % or less of one or more elements M selected from the group consisting of Mo, Nb, Cu, Zr, Al, and V, the balance being composed of Fe and impurities. In this case, a crystal phase having a Scherrer diameter of 50 nm or less is easily produced.

As a specific example of the second particles, the metallic portion thereof may be composed of a Fe—Si—B—Nb—Cu-based alloy. The Fe—Si—B—Nb—Cu-based alloy may be composed of 1.0 to 16.0 atomic % or Si, 1.0 to 15.0 atomic % of B, 0.50 to 8.0 atomic % of Nb, 0.50 to 5.0 atomic % of Cu, and the balance composed of Fe and impurities. In this case, the amount of Fe is preferably 65 atomic % or more.

As another example of when the plurality of amorphous particles have an amorphous phase and a crystal phase, the plurality of amorphous particles are, for example, mixed particles of the first particles and the second particles.

The mixed particles may satisfy at least one of: (a) the mass ratio Ra2 of the second particles relative to the plurality of amorphous particles is 80% by mass or less, and (b) the mass ratio Ra2 of the second particles relative to the plurality of amorphous particles is 1% by mass or more and 60% by mass or less.

The mixed particles may satisfy at least one of: (c) the median diameter D50a1 of the first particles is 3.5 μm or more and 9.0 μm or less, and (d) the median diameter D50a2 of the second particles is 2.0 μm or more and 15.0 μm or less.

In the mixed particles, the median diameter D50a of the plurality of amorphous particles may be calculated as approximate value by formula (2) below, and the calculated median diameter D50a may be 3.0 μm or more and 8.0 μm or less.

$$D 50 a = ( Ra 1 \times D 50 a 1 + Ra 2 \times D 50 a 2 ) / 100 \qquad ( 2 )$$

In addition, the metallic portion of the first particles may contain a crystal phase inevitably produced in the process.

### (4) Soft Magnetic Powder

The median diameter D50 of the soft magnetic metal powder provided in the dust core 1 according to an embodiment of the present invention is approximately calculated by formula (1) below, and is 1.8 μm or more and 7.0 μm or less.

$$D 50 = ( R c \times D 50 c + R a \times D 50 a ) / 100 \qquad ( 1 )$$

With the median diameter D50 within the range described above, the inductor having excellent overall characteristic (μ²×Isat/Pcv)) can be provided. From the viewpoint of more stably enhancing the overall characteristic, the median diameter D50 may be preferably 2.0 μm or more and 5.0 μm or less and may be more preferably 2.5 μm or more and 4.0 μm or less.

The particle diameter of the soft magnetic powder can also be obtained by analyzing an image (secondary electron image) obtained by photographing a section of the dust core 1 using a scanning electron microscope. In this case, the ratio of the occupied sectional area of the plurality of amorphous particles in an observation field relative to the occupied sectional area of the soft magnetic metal powder in the observation field may be 30% or more and 70% or less and is preferably 40% or more and 60% or less.

The shape of the soft magnetic powder is not limited. The shape of the soft magnetic powder may be a spherical shape, an elliptical shape, a scale-like shape, or an irregular shape. A production method for obtaining the shape is also not limited.

The soft magnetic powder may be subjected to surface insulation treatment. When the soft magnetic powder is subjected to surface insulation treatment, the insulation resistance of the dust core 1 is improved. The type of surface insulation treatment performed for the soft magnetic powder is not limited. Examples of the treatment include phosphoric acid treatment, phosphate salt treatment, oxidation treatment, and the like. The soft magnetic powder may have an insulating film on the surface thereof. The insulating film may contain at least one selected from the group consisting of Si, P, and B, and O (oxygen).

### (5) Other Materials

The dust core 1 according to the embodiment of the present invention may further contain an auxiliary arbitrary material in addition to the soft magnetic powder. Examples of the auxiliary material include a binding material and modifier. The binding material bonds, to each other, the particles of the soft magnetic powder and the like contained in the dust core 1. The binding material is preferably an insulating material in order to impart the insulation resistance to the dust core 1.

The binding material may be either an organic material or an inorganic material. The organic material may be a resin material. Examples of the resin material include an acrylic resin, a silicone resin, an epoxy resin, a phenol resin, a urea resin, a melamine resin, a polyester resin, and the like. The inorganic material may be a glass-based material such as water glass. The binding material may be the product of reaction such as thermal decomposition or the like or may be a mixture of a plurality of materials.

The modifier, for example, improves the fluidity of a powder or adjusts the curing rate of the binding material. The modifier may be a glass-based material.

### (6) Iron Loss Pcv

When the iron loss Pcv of the dust core 1 according to the embodiment is measured under the conditions including a frequency of 1 MHz and an effective maximum magnetic flux density Bm of 15 mT, the iron loss Pcv is preferably 70 kW-1 m³ or less. When the iron loss Pcv of the dust core 1 is within the range described above, the overall characteristic of the inductor including the dust core 1 is easily increased. From the viewpoint of more stably increasing the overall characteristic of the inductor, the iron loss Pcv of the dust core 1 measured under the conditions described above is preferably 60 kW-1 m³ or less and more preferably 55 kW-1 m³ or less.

### 2. Method for Producing Dust Core

A method for producing the dust core 1 according to the embodiment of the present invention is not particularly limited, but production of the dust core 1 is more efficiently realized by using a production method described below.

The method for producing the dust core 1 according to the embodiment of the present invention includes a molding step described below and may further include a heat treatment step.

### (1) Molding Step

First, prepared is a mixture containing a magnetic powder and a component which gives a binding component in the dust core 1. The component which gives a binding component (also referred to as a “binder component” in the specification) may be a binding component itself or may be a material different from the binding component. Examples of the latter include a component containing a resin material as a binder component and the residue of thermal decomposition thereof as a binding component. As described later, the thermal decomposition residue can be formed by the heat treatment step performed subsequently to the molding step.

A molded product can be obtained by molding treatment including pressure molding of the mixture. The pressure condition is not limited and is appropriately determined based on the composition of the binder component and the like. For example, when the binder component is composed of a thermosetting resin, the resin in a mold is preferably allowed to proceed by applying pressure and heating. ON the other hand, in the case of compression molding under high pressure, heating is not a necessary condition, and pressure is applied for a short time. The pressure applied in compression molding is appropriately determined. In a non-limited example, the pressure may be 0.5 GPa or more and 2 GPa or less and may be preferably 1 GPa or more and 2 GPa or less.

A somewhat detailed description is given below of the case of compression molding of a granulated powder used as the mixture. The granulated powder is excellent in handleability and thus can improve workability of a compression molding step having a short molding time and excellent productivity.

### 1. Granulated Powder

The granulated powder contains the magnetic powder and the binder component. The content of the binder component in the granulated powder is not particularly limited. In addition, when the content of the binder component is excessively low, the binder component hardly maintains the magnetic powder. Also, when the content of the binder component is excessively low, a plurality of magnetic powders in the dust core 1 obtained through the heat treatment step are hardly insulated from each other by the binding component composed of the thermal decomposition residue of the binder component. While, when the content of the binder component is excessively high, the content of the binding component contained in the dust core 1 obtained through the heat treatment step is easily increased. An increase in the content of the binding component in the dust core 1 easily decreases the magnetic characteristics of the dust core 1. Therefore, the content of the binder component in the granulated powder relative to the whole of the granulated powder is preferably an amount of 0.5% by mass or more and 5.0% by mass or less. From the viewpoint of more stably decreasing the possibility of decrease in magnetic characteristics of the dust core 1, the content of the binder component in the granulated powder relative to the whole of the granulated powder is preferably an amount of 1.0% by mass or more and 3.5% by mass or less and more preferably an amount of 1.2% by mass or more and 3.0% by mass or less.

The granulated powder may contain a material other than the magnetic powder and the binder component. Examples of the material include a lubricant, a silane coupling agent, an insulting filler, and the like. When the lubricant is contained, the type thereof is not particularly limited and may be an organic lubricant or an inorganic lubricant. Examples of the organic lubricant include metal soaps such as zinc stearate, aluminum stearate, and the like. The organic lubricant is considered to be vaporized in the heat treatment step and little remains in the dust core 1.

A method for producing the granulated powder is not particularly limited. The granulated powder may be obtained by grinding the kneaded material obtained by directly kneading a component, which provides the granulated powder, by a known method or the granulated powder may be obtained by adding a dispersion medium (water as an example) to the component to prepare a slurry and drying and grinding the slurry. In addition, the particle size distribution of the granulated powder may be controlled by sieving or classification after grinding.

An example of a method for obtaining the granulated powder from the slurry is a method using a spray dryer. As shown in FIG. 2, a rotor 201 is provided in a spray dryer device 200, and the slurry S is injected to the rotor 201 from the upper portion of the device. The rotor 201 is rotated at a predetermined number of rotations, and the slurry S is sprayed as droplets by centrifugal force in a chamber in the spray dryer device 200. Further, hot air is introduced into the chamber in the spray dryer device 200, thereby evaporating the dispersion medium (water) contained in the droplets of the slurry S while maintaining the droplet shape. Consequently, the granulated powder P is formed from the slurry S. The granulated powder P is recovered from a lower portion of the spray dryer device 200. Each of the parameters such as the number of rotations of the rotor 201, the temperature of hot air introduced into the spray dryer device 200, the temperature of the lower portion of the chamber, etc. may be appropriately determined. Examples of the setting ranges of these parameters include 4000 to 8000 rpm as the number of rotations of the rotor 201, 100° C. to 170° C. as the temperature of hot air introduced into the spray dryer device 200, and 80° C. to 90° C. as the temperature of the lower portion of the chamber. The atmosphere and pressure in the chamber may also be appropriately determined. For example, the atmosphere in the chamber is air, and the pressure in the chamber is 2 mmH₂O (about 0.02 kPa) in terms of the differential pressure from the atmospheric pressure. The particle size distribution of the resultant granulated powder P may be further controlled by sieving or the like.

### 1. Pressurization Condition

The pressurization conditions of compression molding are not particularly limited. The conditions may be properly determined in consideration of the composition of the granulated powder, the shape of the molded product, etc. When the pressure applied for compression molding of the granulated powder is excessively low, the mechanical strength of the molded product is decreased. This easily causes the problems such as a decrease in handleability of the molded product and a decrease in mechanical strength of the dust core 1 obtained from the molded product. Also, the magnetic characteristics of the dust core 1 may be decreased, and insulation may be decreased. On the other hand, when the pressure applied for compression molding of the granulated powder is excessively high, it is difficult to form a molding mold which can withstand the pressure. From the viewpoint of stably decreasing the possibility that the compression pressurization step adversely influence the mechanical characteristics and magnetic characteristics of the dust core 1 and facilitating the industrial mass production thereof, the pressure applied for compression molding of the granulated powder is preferably 0.3 GPa or more and 2 GPa or less, more preferably 0.5 GPa or more 2 GPa or less, and particularly preferably 0.8 GPa or more and 2 GPa or less.

In compression molding, pressure may be applied under heating or at room temperature.

### (2) Heat Treatment Step

The molded product obtained by the molding step may be the dust core 1 according to the embodiment or the dust core 1 may be obtained by performing the heat treatment step for the molded product as described next.

In the heat treatment step, the distance between the magnetic powders is modified by heating the molded product obtained by the molding step, and thus the magnetic characteristics are adjusted. Also, the magnetic characteristics are adjusted by relaxing the strain imparted to the magnetic powder in the molding step, thereby producing the dust core 1.

As described above, the purpose of the heat treatment step is to adjust the magnetic characteristics of the dust core 1, and thus the heat treatment conditions such as the heat treatment temperature and the like are determined so as to provide the best magnetic characteristics of the dust core 1. An example of the method for setting the heat treatment conditions is a method in which the maximum value (annealing temperature) of the heating temperature of the molded product is changed, and other conditions such as the heating rate and the retention time at the heating temperature are constant.

In setting the heat treatment conditions, the evaluation criteria of the magnetic characteristics of the dust core 1 are particularly not limited. An example of the evaluation items is the iron loss Pcv of the dust core 1. In this case, the heating temperature of the molded product may be determined so as to minimize the iron loss Pcv of the dust core 1. As described later, the iron loss Pcv of the dust core 1 according to the embodiment tends to be decreased with decreasing annealing temperature within an annealing temperature range of 325° C. to 400° C.

The atmosphere for heat treatment is not particularly limited. An oxidizing atmosphere increases the possibility that thermal decomposition of the binder component excessively proceeds and the possibility that oxidation of the magnetic powder proceeds. Therefore, the heat treatment is preferably performed in an inert atmosphere of nitrogen, argon, or the like or a reducing atmosphere of hydrogen or the like. When the binder component is formed of a resin material, the binder component may become the thermal decomposition residue by the heat treatment as described above. The binder component is considered to become the thermal decomposition residue by relaxation of strain as described above.

### 3. Inductor and Electronic Electric Devices

The inductor according to the embodiment of the present invention includes a connection terminal for electrical connection to a substrate, a conductor electrically connected to the connection terminal and capable of generating an induction magnetic field by current application, and the dust core 1 according to the embodiment of the present invention. In the inductor, the dust core 1 is disposed at a position through which a line of magnetic force of the induction magnetic field from the conductor passes. The inductor according to the embodiment of the present invention includes the dust core 1 according to the embodiment of the present invention and thus has excellent overall characteristic (μ²×Isat/Pcv).

In the specification, the overall characteristic is determined by relative initial permeability μ at 1 MHz, iron loss Pcv at 1 MHz, and DC superimposition rated current Isat. There is requirement to increase both the self-inductance L and DC superimposition rated current Isat as the product characteristics of the inductor. The self-inductance L has a proportional relationship to the relative initial permeability μ, and thus (μ×Isat) is an index for evaluating the characteristics of the inductor. The (μ×Isat) varies according to the value of relative initial permeability μ even with the same composition. Therefore, in comparison with same relative initial permeability μ, the inductor having higher (μ×Isat) has more excellent characteristics. In addition, as an index apart from the viewpoint described above, for example, the dust core 1 has low iron loss Pcv.

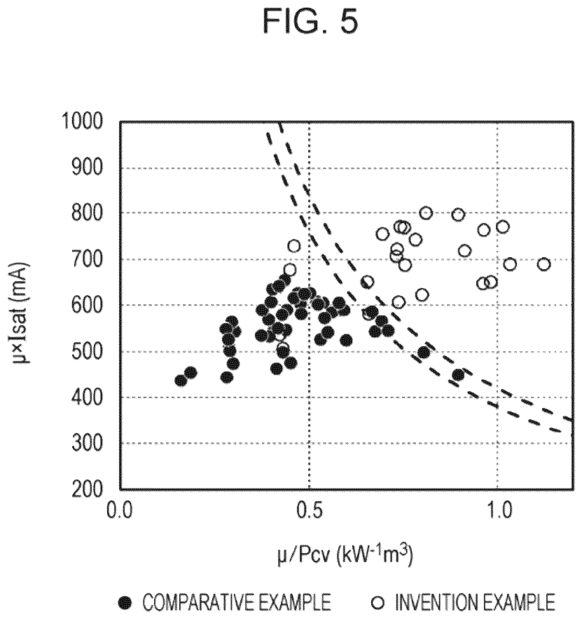

Therefore, the measurement results of the inductor (and the dust core 1 constituting it) are plotted by taking μ×Isat as ordinate and u/Pcv as abscissa. The resultant graph shows that the more-upper right the plots are, the more excellent the inductor (and the dust core 1 constituting it) is. FIG. 5 is a graph illustrating the characteristics of the inductor including the dust core 1 according to the embodiment of the present invention, and the graph is obtained by plotting the values of inductors (invention examples) each including the dust core 1 according to the embodiment of the present invention and inductors (comparative examples) each including a dust core other than the dust core 1 according to the embodiment of the present invention. In FIG. 5, broken lines respectively show μ²×Isat/Pcv=380 mA·kW⁻¹ m³ and μ²×Isat/Pcv=420 mA·kW⁻¹ m³, and a boundary region which separates between the invention examples and the comparative examples is generally present at μ²×Isat/Pcv of about 400 mA·kW⁻¹ m³.

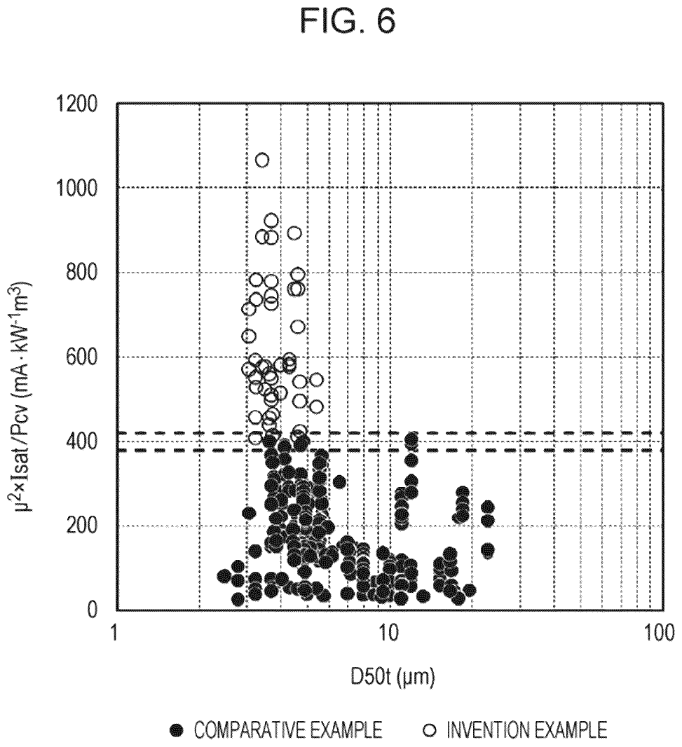

FIG. 6 is a diagram illustrating the relationship between the characteristic and the median diameter D50 of the inductor including the dust core according to the embodiment of the present invention. FIG. 6 shows overall characteristic (μ²×Isat/Pcv) as ordinate based on the results used for plots of the graph of FIG. 5 and the median diameter D50 of the dust core 1 as abscissa. It is confirmed that the invention examples are located within a median diameter D50 region of 1.8 μm or more and 7.0 μm or less.

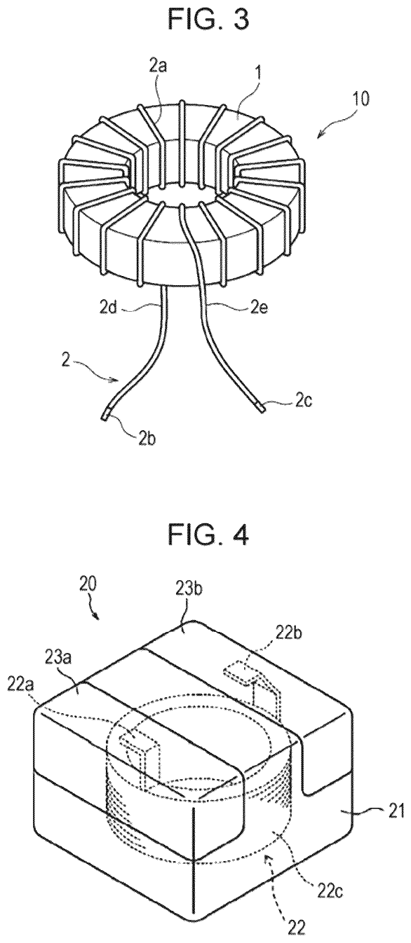

An example of the inductor is a toroidal coil 10 shown in FIG. 3. The toroidal coil 10 includes a coil 2a formed by winding a coated conductive wire 2 on a ring-shaped dust core (toroidal core) 1. The ends 2d and 2e of the coil 2a are defined in the portions positioned between the coil 2a composed of the wound coated conductive wire 2 and the ends 2b and 2c, respectively, of the coated conductive wire 2. Therefore, in the inductor according to the embodiment, the member constituting the coil and the member constituting the connection terminal may be the same member.

Another example of the inductor according to the embodiment of the present invention is a coil-embedded type inductor 20 shown in FIG. 4. The coil-embedded type inductor 20 can be formed in a chip shape having a several mm square small size, and includes a dust core 21 having a box-like shape in which a coil portion 22c of a coated conductive wire 22 is embedded. The conductor of the coil portion 22c generates induction magnetic field by current application, and a line of magnetic force of the induction magnetic field passes through the dust core 21. The ends 22a and 22b of the coated conductive wire 22 are located and exposed from the surface of the dust core 21. A portion of the surface of the dust core 21 is coated with the connection ends 23a and 23b which are electrically independent from each other. The connection end 23a is electrically connected to the end 22a of the coated conductive wire 22, and the connection end 23b is electrically connected to the end 22b of the coated conductive wire 22. In the coil-embedded type inductor 20 shown in FIG. 4, the end 22a of the coated conductive wire 22 is coated with the connection end 23a, and the end 22b of the coated conductive wire 22 is coated with the connection end 23b.

A method for embedding the coil portion 22c of the coated conductive wire 22 in the dust core 21 is not limited. A member including the wound coated conductive wire 22 may be disposed in a mold, and a mixture (granulated powder) containing a magnetic powder may be further supplied in the mold, followed by pressure molding. Alternatively, a plurality of members formed by previous molding of a mixture (granulated powder) containing a magnetic powder are prepared, and these members may be assembled. Then, an assembly may be obtained by disposing the coated conductive wire 22 in the space formed by assembling the members, and then the assembly may be pressure-molded. The material of the coated conductive wire 22 containing the coil portion 22c is not limited. Examples of the material include copper and a copper alloy. The coil portion 22c may be an edgewise coil. In addition, the material of the connection ends 23a and 23b is also not limited. From the viewpoint of excellent conductivity, the material may preferably include a metallized layer formed from a conductive paste such as a silver paste or the like, and a plate layer formed on the metallized layer. The material forming the plate layer is not limited. Examples of a metal element contained in the material include copper, aluminum, zinc, nickel, iron, tin, and the like.

The electronic/electric device according to the embodiment of the present invention is an electronic/electric device provided with the inductor according to the embodiment of the present invention, and the inductor is connected to a substrate through a connection terminal. An example of a circuit including the inductor is a switching power source circuit such as a DC-DC converter. In order to comply with various requirements for smaller size, lighter weight, higher functionality of the electronic/electric device, the switching power source circuit tends to have a higher switching frequency and an increased quantity of current flowing through the circuit. Thus, the current flowing through the inductor as a component of the circuit also tends to have a higher variable frequency and an increased average current quantity.

In regard to this point, as described above, the dust core 1 according to the embodiment of the present invention has the excellent DC superimposition characteristic, and thus the inductor including the dust core 1 can be properly operated in a high-magnetic-field environment. In addition, the dust core 1 of the inductor according to the embodiment of the present invention has low iron loss Pcv, and thus the switching power source circuit including the inductor suppresses a decrease in efficiency and hardly causes a problem with heat generation. Thus, the electronic/electric device provided with the inductor according to the embodiment of the present invention can realize higher functionality while complying with smaller size and lighter weight.

The embodiments described above are described for facilitating the understanding of the present invention, and are not described for limiting the present invention. Therefore, the meaning of each of the factors disclosed in the embodiments includes all design changes and equivalents belonging to the technical scope of the present invention.

### EMBODIMENTS

The present invention is described in further detail below by giving examples and the like, but the scope of the present invention is not limited to these examples and the like.

### Example 1-1 to Example 33

### (1) Preparation of Magnetic Powder

There were prepared three types of crystalline particles (commercial product) having a metallic portion, composed of a crystalline phase, and different median diameters D50c (0.3 μm, 0.6 μm, and 0.92 μm) and composed of a Fe—Ni alloy having a Ni content of 50% by mass and the balance composed of Fe and impurities. The crystalline particles were not subjected to insulation surface treatment.

Also, prepared were crystalline particles (commercial product) (median diameters D50c: 2.0 μm) having a metallic portion, composed of a crystalline phase, and composed of a Fe—Si—Cr alloy, having a Si content of 3.5% by mass, a Cr content of 4.5% by mass, and the balance composed of Fe and impurities. The crystalline particles were not subjected to insulation surface treatment.

Law materials were weighed so as to have a predetermined composition containing Fe, Ni, Cr, P, C, and B as elements, and a Fe—P—C-based alloy was smelted, and the resultant Fe—P—C-based alloy was used for a water atomization method to form, as first particles, five types of particles having a metallic portion composed of an amorphous phase and different median diameters D50a1 (5.5 μm, 6.5 μm, 8.0 μm, 11.0 μm, and 12.0 μm). The chemical composition of the first particles was composed of 6 atomic % of Ni, 2 atomic % of Cr, 11 atomic % of P, 8 atomic % of C, 2 atomic % of B, and balance composed of Fe and impurities. The first particles were not subjected to insulation surface treatment.

Also, second particles (commercial product) having Fe, Si, B, Nb, and Cu as elements, a metallic portion composed of a crystal phase having a Scherrer diameter of 50 nm or less and an amorphous phase, and different median diameters D50a2 (four types: 4.0 μm, 11 μm, 15 μm, and 27 μm). The surfaces of the second particles were subjected to insulation coating treatment.

The particle size distributions of the prepared crystalline powder (crystalline particles), single-phase amorphous powder (first particles), and nano-crystal powder (second particles) were measured as a volume distribution by a laser diffraction/scattering method using a particle size analyzer (manufactured by Nikkiso Co., Ltd., “Microtrac particle size distribution measurement device MT3300EX”). In the volume-based particle size distribution, the particle diameter (median diameter, unit: μm) at 50% in the cumulative particle diameter distribution from the smaller particle diameter side in the volume-based particle size distribution was determined.

### (2) Formation of Granulated Powder

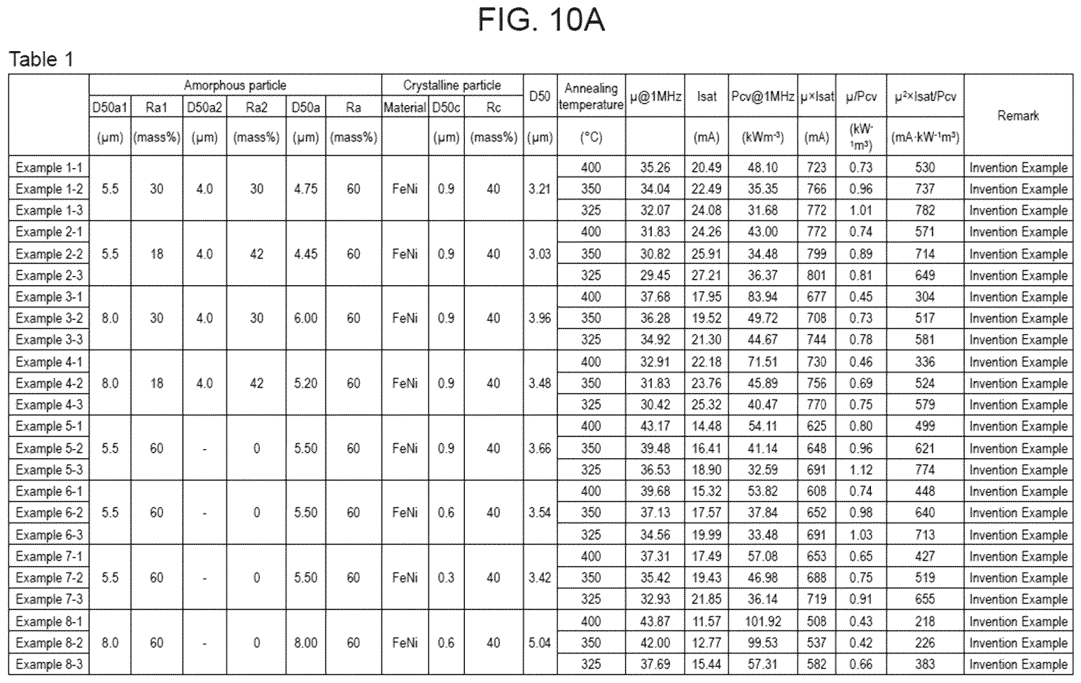

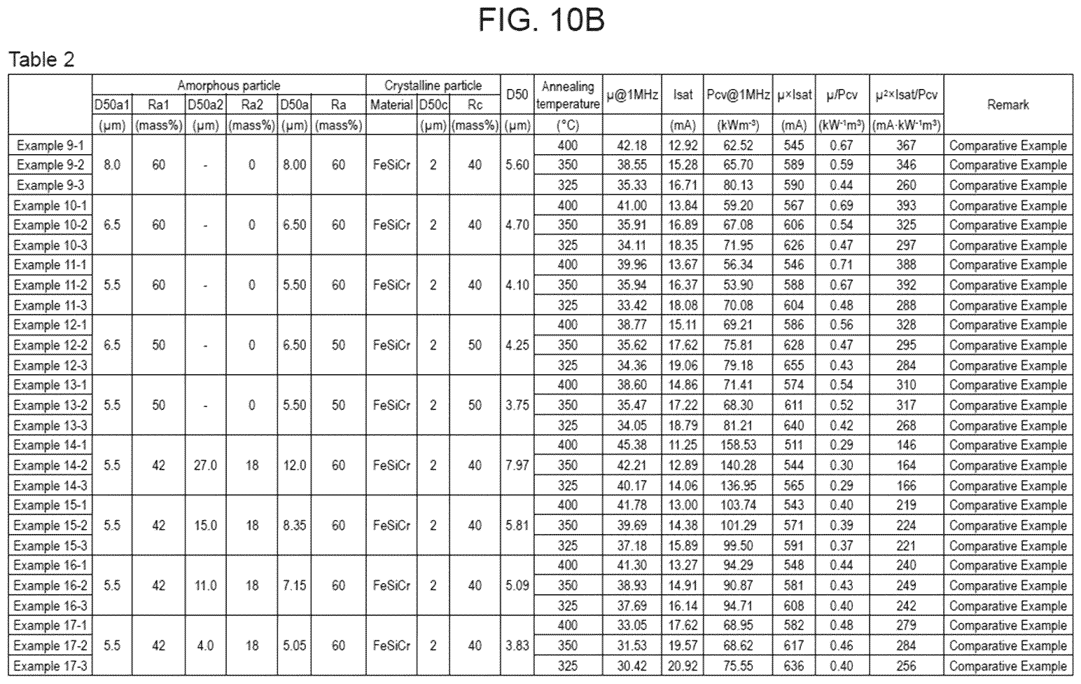

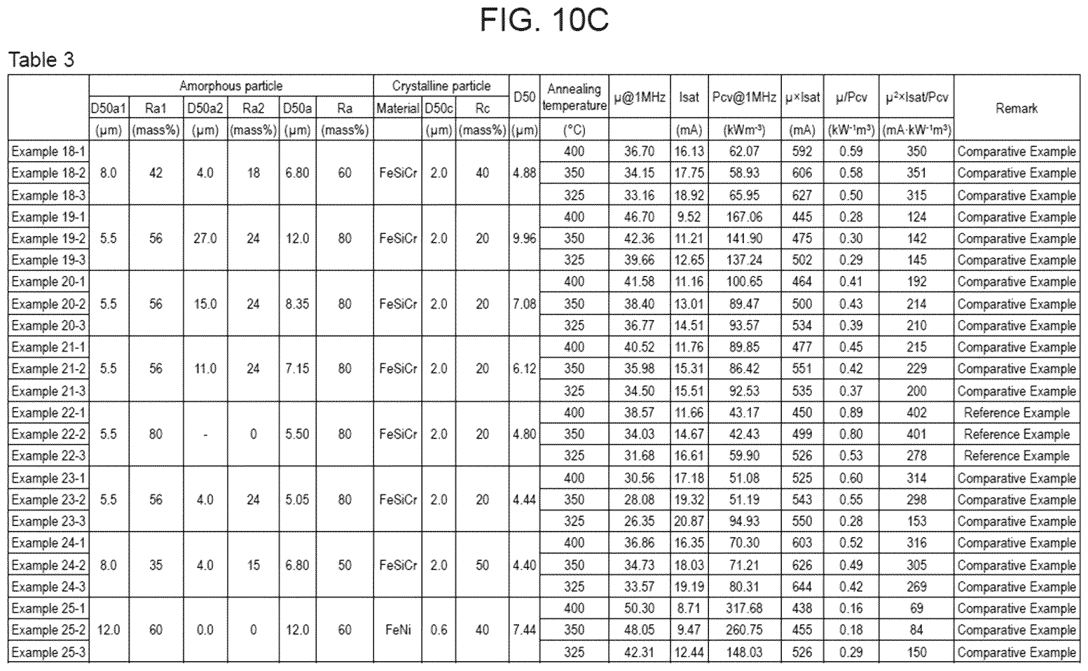

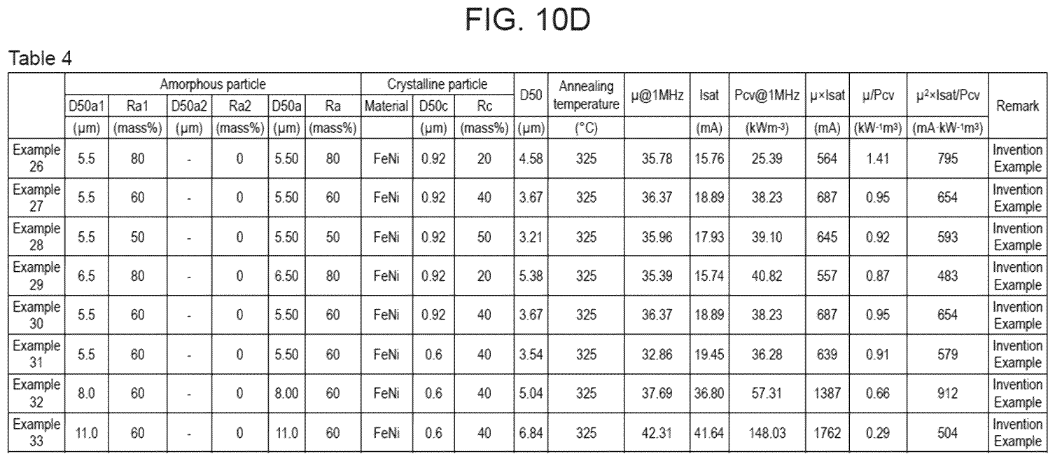

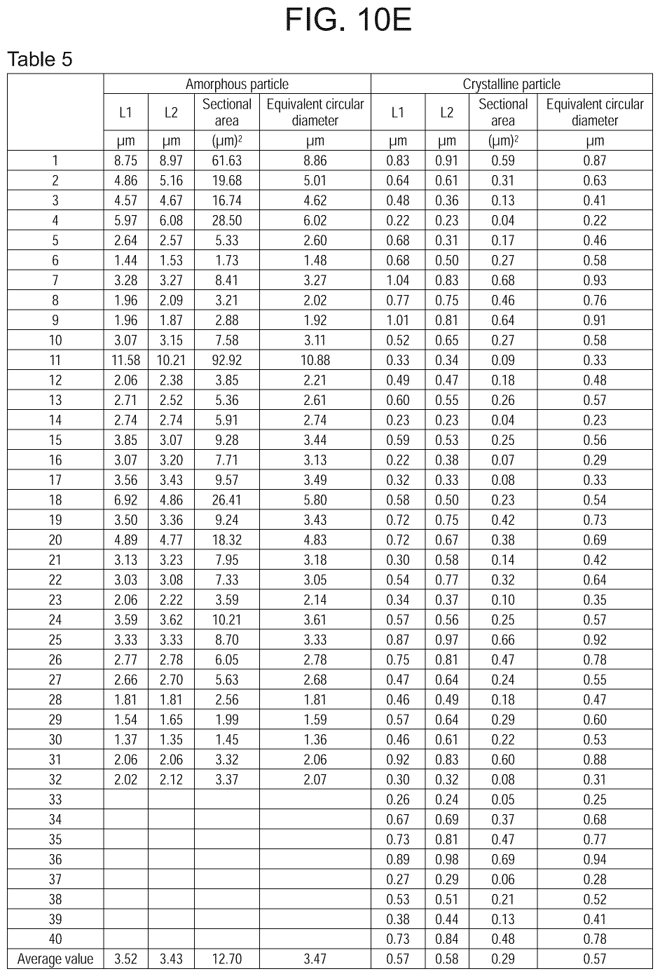

As shown in Table 1 to Table 4 in FIG. 10A to FIG. 10D, two or three types were selected from the first particles, the second particles, and the crystalline particles and mixed at a predetermined ratio shown in each of the tables to produce a magnetic powder, and the median diameter D50 thereof was determined. The calculated results of median diameter D50 (unit: μm) are shown in Table 1 to Table 4.

Mixed were 100 parts by mass of the resultant mixed powder, 2 to 3 parts by mass of an insulating binder composed of an acrylic resin and a phenol resin, and 0 to 0.5 parts by mass of a lubricant composed of zinc stearate. Further, water was used as a solvent to prepare a slurry.

The resultant slurry was granulated by using the spray dryer device 200 shown in FIG. 2 under the conditions described above, producing a granulated powder.

### (3) Compression Molding

The resultant granulated powder was filled in a mold and pressure-molded under a surface pressure of 980 MPa, producing a molded product having a ring shape of 20 mm in outer diameter×12 mm inner diameter×3 mm in thickness.

### (4) Heat Treatment

The resultant molded product was placed in a furnace having a nitrogen stream atmosphere, and heat treatment was performed by increasing the temperature in the furnace from room temperature (23° C.) to the annealing temperature shown in Table 1 to Table 4 (FIG. 10A to FIG. 10D) at a heating rate of 10° C./min, maintaining in the furnace at the temperature for 1 hour, and then cooling to room temperature in the furnace, producing a toroidal core including the dust core 1.

### Test Example 1: Measurement of Relative Initial Permeability μ

A coated copper wire was wound 20 times on the toroidal core formed in each of the examples, producing a toroidal coil. The relative initial permeability μ of the resultant toroidal coil was measured by using an impedance analyzer (manufactured by HP Inc., “4192A”) under the condition of 1 MHz. The measurement results are shown in Table 1 to Table 4 (FIG. 10A to FIG. 10D).

### Test Example 2: Measurement of Iron Loss Pcv

A coated copper wire was wound 15 times on the primary side and 10 turns on the secondary side of the toroidal core formed in each of the examples, producing a toroidal coil. The iron loss Pcv (unit: kW/m³) of the resultant toroidal coil was measured by using a BH analyzer (manufactured by Iwasaki Tsushinki Co., Ltd., “SY-8217”) under the condition of effective maximum magnetic flux density Bm of 15 mT at a measurement frequency of 1 MHz. The measurement results are shown in Table 1 to Table 4 (FIG. 10A to FIG. 10D).

### Test Example 3: DC Superimposition Rated Current Isat

An inductance element was formed by winding a copper wire on the toroidal core formed in each of the examples. The DC superimposition rated current Isat (unit: mA) of the resultant inductance element was determined as a current value at which the self-inductance L was decreased by 30% due to DC superimposition. In this case, Isat was determined by winding a copper wire 34 turns on a toroidal-shaped core of 20 mm in outer diameter, 12.7 mm in inner diameter, and 3.1 mm in height and flowing a current therethrough. The measurement results are shown in Table 1 to Table 5 (FIG. 10A to FIG. 10E).

### Evaluation Example 1: Overall Characteristics μ²×Isat/Pcv

Based on the results measured in Test Example 1 to Test Example 3, μ²×Isat/Pcv (unit: mA·kW⁻¹ m³) was calculated as the overall characteristic. The measurement results are shown in Table 1 and Table 5 (FIG. 10A to FIG. 10E).

As shown in Table 1 to Table 3, it was confirmed that when the median diameter D50c of the crystalline particles is 1.3 μm or less, the median diameter D50a of the amorphous particles is 2.0 μm or more and 12.0 μm or less, and the median diameter D50 of the soft magnetic metal powder is 1.8 μm or more and 7.0 μm or less, the overall characteristic (μ²×Isat/Pcv) is improved. In particular, it was recognized that when the iron loss Pcv is 70 kW-1 m³ or less, the overall characteristic (μ²×Isat/Pcv) of 400 mA·kW⁻¹ m³ is easily realized, and from the viewpoint of more stably realizing the overall characteristic of 400 mA·kW⁻¹ m³, the iron loss Pcv is preferably 60 kW-1 m³ or less and more preferably 55 kW-1 m³ or less.

In regard to the relationship between the annealing temperature and the overall characteristic, it was confirmed from the comparison of the results shown in Table 1 to Table 3 that when the crystalline particles contain the Fe—Ni alloy, the overall characteristic tends to be increased with decreasing annealing temperature, while when the crystalline particles contain the Fe—Si—Cr alloy, conversely, the overall characteristic tends to be decreased with decreasing annealing temperature. In addition, even when the crystalline particles contain the Fe—Si—Cr alloy, the inductor having excellent overall characteristic may be obtained. Specifically, this case corresponds to Example 22 which is shown as a reference example in Table 3. However, when the crystalline particles contain the Fe—Si—Cr alloy, the median diameter D50c range of the crystalline particles in which the good overall characteristic can be obtained is limited. Therefore, the crystalline particles containing the Fe—Ni alloy have a wider median diameter D50c range of the crystalline particles in which the good overall characteristic can be obtained, as compared with the crystalline particles containing the Fe—Si—Cr alloy. Thus, it is considered that the crystalline particles containing the Fe—Ni alloy are excellent from the viewpoint of design freedom and the ease of quality control.

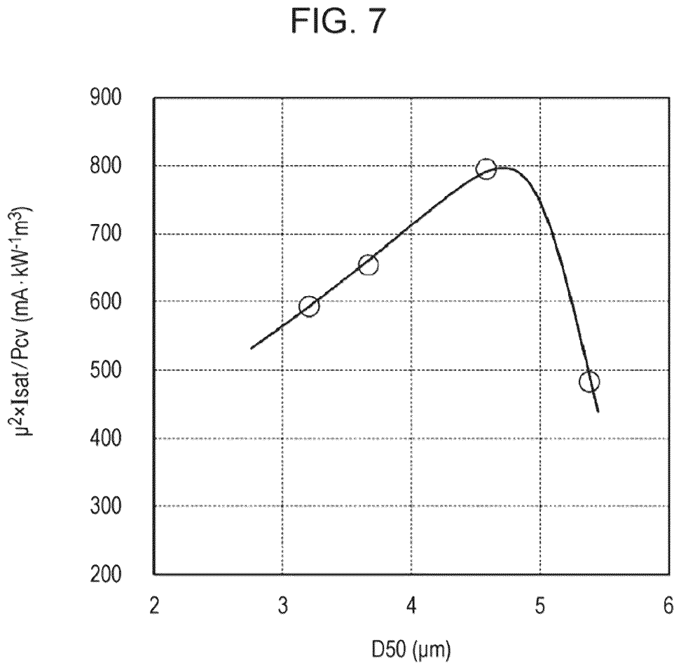

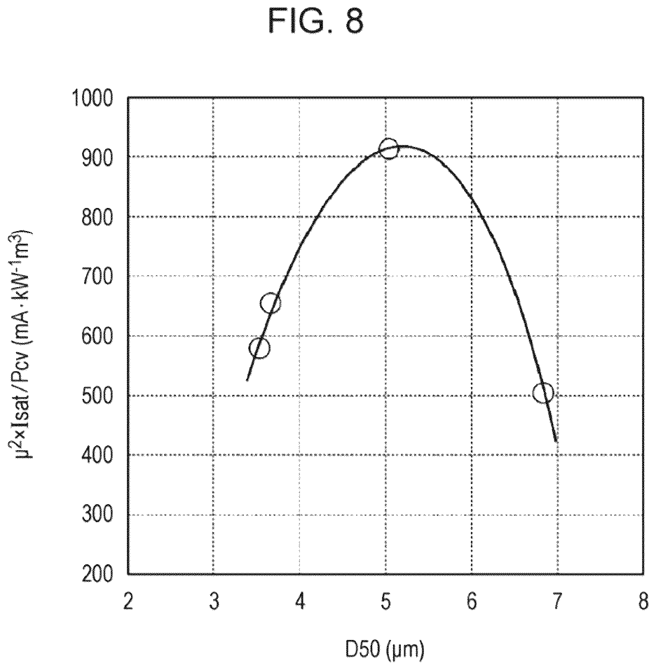

FIG. 7 is a graph of the results shown in Example 26 to Example 29, and FIG. 8 is a graph of the results shown in Example 30 to Example 33. As understood from the graphs, even within the scope of the present invention, the overall characteristic (μ²×Isat/Pcv) can be enhanced by optimizing the median diameter D50 of the magnetic powder. Specifically, the median diameter D50 of the magnetic powder is more preferably 3 μm or more and 5.5 μm or less and particularly preferably 3.5 μm or more and 5 μm or less.

### Evaluation Example 2: Average Equivalent Circular Diameter of Particles

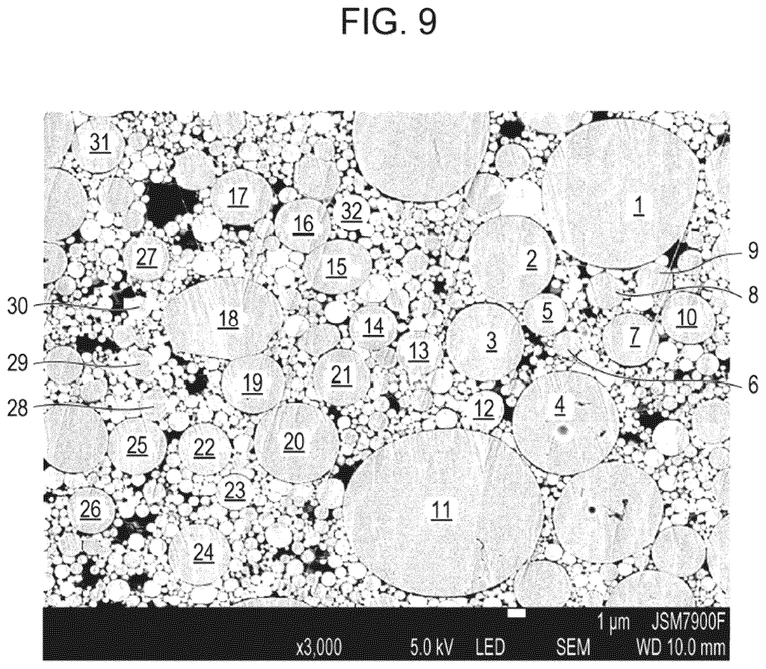

A section of the dust core according to Example 5-3 was photographed by a scanning electron microscope to obtain a secondary electron image (FIG. 9). As shown in FIG. 9, 32 amorphous particles located in the field of view of the secondary electron image were randomly selected, and the equivalent circular diameters thereof were determined. FIG. 9 shows the numbers of the amorphous particles selected as measurement objects. Also, 40 crystalline particles located between the amorphous particles were randomly selected, and the equivalent circular diameters thereof were determined. A method for determining the equivalent circular diameters was as follows. First, in each of the particles selected, the length L1 (unit: μm) in the lateral direction and length L2 (unit: μm) in the longitudinal direction of the particle in the image were measured. Based on the measurement results, the approximate value of the sectional area of the particle was determined by L1×L2×‰/4, and the equivalent circular diameter was determined from the approximate value. The measurement results and calculation results are shown in Table 5 (FIG. 10E). Table 5 shows the average value, maximum value, and minimum value of the amorphous particles and the crystalline particles, and the median diameter based on the particle size distribution measurement by a laser diffraction/scattering method.

As shown in Table 5, the median diameter D50a of the amorphous particles is 5.5 μm, but the average value of equivalent circular diameters is 3.47 μm and is a value of 63% of the median diameter D50a. On the other hand, the median diameter D50a of the crystalline particles is 0.9 μm, but the average value of equivalent circular diameters is 0.57 μm and is a value of 63% of the median diameter D50c. Thus, the equivalent circular diameter was calculated to be 63% of the median diameter.

The inductor including the dust core of the present invention can be preferably used as an inductor serving as a component of a switching power source circuit such as a Dc-Dc converter or the like.

1. A dust core comprising:
a soft magnetic metal powder containing:
a plurality of crystalline particles having a composition containing Fe and Ni; and
a plurality of amorphous particles,
wherein a median diameter D50c of the plurality of crystalline particles is equal to or smaller than 1.3 μm, and a median diameter D50a of the plurality of amorphous particles is equal to or greater than 2.0 μm and equal to or smaller than 12.0 μm,
wherein a median diameter D50 of the soft magnetic metal powder is calculated by formula (1) below:
$$D 50 = ( R c \times D 50 c + R a \times D 50 a ) / 100 , \qquad ( 1 )$$
in which Rc is a mass ratio (unit: % by mass) of the plurality of crystalline particles relative to the soft magnetic metal powder, and Ra is a mass ratio (unit: % by mass) of the plurality of amorphous particles relative to the soft magnetic metal powder,
and wherein the median diameter D50 is equal to or greater than 1.8 μm and equal to or smaller than 7.0 μm.

2. The dust core according to claim 1, wherein a metallic portion of the plurality of amorphous particles is formed of an amorphous phase.

3. The dust core according to claim 1, wherein the median diameter D50a of the plurality of amorphous particles is equal to or greater than 3.5 μm and equal to or smaller than 9.0 μm.

4. The dust core according to claim 1, wherein median diameter D50c the plurality of crystalline particles is equal to or greater than 0.50 μm and equal to or smaller than 1.3 μm.

5. The dust core according to claim 1, wherein the mass ratio Ra of the plurality of amorphous particles relative to the soft magnetic metal powder is equal to or greater than 10% by mass and equal to or smaller than 90% by mass.

6. The dust core according to claim 5, wherein mass ratio Ra of the plurality of amorphous particles relative to the soft magnetic metal powder is equal to or greater than 35% by mass and equal to or smaller than 85% by mass.

7. The dust core according to claim 1, wherein the plurality of crystalline particles have a composition containing equal to or greater than 10% by mass and equal to or smaller than 90% by mass of Ni, and a balance composed of Fe and impurities.

8. The dust core according to claim 1, wherein the plurality of amorphous particles include a metallic portion having a composition containing:
P: 5.0 to 13.0 atomic %;
C: 2.2 to 13.0 atomic %;
Ni: 0 to 10.0 atomic %;
B: 0 to 9.0 atomic %;
Si: 0 to 7.0 atomic %;
Cr: 0 to 6.0 atomic %;
Sn: 0 to 3.0 atomic %; and
a balance composed of Fe and impurities.

9. The dust core according to claim 1, wherein the plurality of amorphous particles include:
first particles including a metallic portion composed of an amorphous phase; and
second particles including a metallic portion composed of a crystal phase having a Scherrer diameter of equal to or smaller than 50 nm, and an amorphous phase.

10. The dust core according to claim 9, wherein a mass ratio Ra2 of the second particles relative to the plurality of amorphous particles is equal to or smaller than 80% by mass.

11. The dust core according to claim 10, wherein the mass ratio Ra2 of the second particles relative to the plurality of amorphous particles is equal to or greater than 1% by mass and equal to or smaller than 60% by mass.

12. The dust core according to claim 9, wherein a median diameter D50a1 of the first particles is equal to or greater than 3.5 μm and equal to or smaller than 9.0 μm.

13. The dust core according to claim 9, wherein a median diameter D50a2 of the second particles is equal to or greater than 2.0 μm and equal to or smaller than 15 μm.

14. The dust core according to claim 9, wherein the median diameter D50a of the plurality of amorphous particles is calculated by formula (2) below
$$D 50 a = ( Ra 1 \times D 50 a 1 + Ra 2 \times D 50 a 2 ) / 100 , \qquad ( 2 )$$
in which Ra1 is a mass ratio (unit: % by mass) of the first particles relative to the plurality of amorphous particles, and Ra2 is a mass ratio (unit: % by mass) of the second particles relative to the plurality of amorphous particles,
wherein the median diameter D50a is equal to or greater than 3.0 μm and equal to or smaller than 8.0 μm.

15. The dust core according to claim 9, wherein the median diameter D50c of the plurality of crystalline particles is equal to or greater than 0.5 μm and equal to or smaller than 1.3 μm.

16. The dust core according to claim 9, wherein the mass ratio Ra of the plurality of amorphous particles relative to the soft magnetic metal powder is equal to or greater than 10% by mass and equal to or smaller than 90% by mass.

17. The dust core according to claim 16, wherein the mass ratio Ra of the plurality of amorphous particles relative to the soft magnetic metal powder is equal to or greater than 35% by mass and equal to or smaller than 60% by mass.

18. The dust core according to claim 9, wherein the plurality of crystalline particles include a metallic portion having a composition containing equal to or greater than 10% by mass and equal to or smaller than 90% by mass of Ni and a balance composed of Fe and impurities.

19. The dust core according to claim 9, wherein the plurality of amorphous particles include a metallic portion having a composition containing:
P: 5.0 to 13.0 atomic %;
C: 2.2 to 13.0 atomic %;
Ni: 0 to 10.0 atomic %;
B: 0 to 9.0 atomic %;
Si: 0 to 7.0 atomic %;
Cr: 0 to 6.0 atomic %;
Sn: 0 to 3.0 atomic %; and
a balance composed of Fe and impurities.

20. The dust core according to claim 9, wherein the second particles have a composition containing:
at least one element X selected from the group consisting of C, B, P, and Si: equal to or greater than 5 atomic % and equal to or smaller than 20 atomic %;
at least one element M selected from the group consisting of Mo, Nb, Cu, Zr, Al, and V: equal to or greater than 1 atomic % and equal to or smaller than 10 atomic %; and
a balance composed of Fe and impurities.

21. The dust core according to claim 1, wherein:
the median diameter D50a of the plurality of amorphous particles is equal to or greater than 3.5 μm and equal to or smaller than 9.0 μm;
the median diameter D50c of the plurality of crystalline particles is equal to or greater than 0.50 μm and equal to or smaller than 1.3 μm;
the mass ratio Ra of the plurality of amorphous particles relative to the soft magnetic metal powder is equal to or greater than 35% by mass and equal to or smaller than 60% by mass; and
the plurality of amorphous particles include a metallic portion composed of an amorphous phase and having a composition containing:
P: 5.0 to 13.0 atomic %;
C: 2.2 to 13.0 atomic %;
Ni: 0 to 10.0 atomic %;
B: 0 to 9.0 atomic %;
Si: 0 to 7.0 atomic %;
Cr: 0 to 6.0 atomic %;
Sn: 0 to 3.0 atomic %; and
a balance composed of Fe and impurities.

22. The dust core according to claim 1, wherein the dust core has such magnetic characteristics, under a frequency of 1 MHz and an effective maximum magnetic flux density Bm of 15 mT, that includes an iron loss Pcv which is equal to or smaller than 70 kw⁻¹ m³.

23. A dust core comprising:
a soft magnetic metal powder containing:
a plurality of crystalline particles; and
a plurality of amorphous particles,
wherein, observed in a cross section of the dust core, an average equivalent circular diameter of the plurality of crystalline particles is equal to or smaller than 1.0 μm, an average equivalent circular diameter of the plurality of amorphous particles is equal to or greater than 1.0 μm and equal to or smaller than 8.0 μm, and a ratio of an area occupied by the plurality of amorphous particles to an area occupied by the soft magnetic metal powder in the cross section is equal to or greater than 30% and equal to or smaller than 70%.

24. An inductor comprising:
a connection terminal;
a conductor electrically connected to the connection terminal, the conductor being configured to generate an induction magnetic field by applying an electric current; and
the core according to claim 1,
wherein the dust core is disposed in a position through which a line of magnetic force of the induction magnetic field from the conductor passes.

25. An electronic/electric device comprising:
a substrate; and
the inductor according to claim 24, wherein the inductor is connected to the substrate through the connection terminal.
